(19) United States
(12) Patent Application Publication
(10) Pub. No.: US 2023/0271852 A1
(43) Pub. Date: Aug. 31, 2023

(54) HEAVY METAL ADSORBENT

(71) Applicant: Sinanen Zeomic Co., Ltd., Nagoya-shi, (JP)

(72) Inventors: Akio TANIGUCHI, Tokai-shi (JP); Naoyuki INOUE, Ichinomiya-shi (JP)

(73) Assignee: Sinanen Zeomic Co., Ltd., Nagoya-shi, (JP)

(21) Appl. No.: 18/173,219

(22) Filed: Feb. 23, 2023

(30) Foreign Application Priority Data
Feb. 25, 2022 (JP) 2022-027588

(51) Int. Cl. C02F 1/28; C02F 1/62; B01J 20/02; B01J 20/18; B01J 20/28

(52) U.S. Cl. CPC C02F 1/281; C02F 1/62; B01J 20/0211; B01J 20/18; B01J 20/28059; B01J 20/28071; B01J 20/28083; C02F 2101/20

(57) ABSTRACT

To provide a material capable of adsorbing lead from water with a pH of 8 or more. A porous body of a titanium-containing compound, which has a bulk specific gravity of 0.4 g/cm³ or less, is used as an adsorbent.

### BACKGROUND OF THE INVENTION

### Technical Field

The present invention relates to a heavy metal adsorbent.

### Background Art

The lead concentration in tap water is one of water quality standards in Japan because of concerns about health effects of lead. It is believed that lead included in tap water is derived from a lead pipe which was used as a water pipe until the early 1900s.

A zeolite (aluminosilicate-based inorganic ion exchanger) capable of adsorbing heavy metals such as lead included in water is used as an adsorbent for water purifier (PTL 1). An amorphous titanosilicate is also used as an adsorbent for water purifier (PTL2)

There has been known that the existence form of lead existing in water varies depending on the pH of the water (Non NPL 1). When the pH of water is less than 8, lead has a high tendency to dissolve in water and exist as lead ions. When the pH of water is 8 or more, lead ions are partially converted into colloids of a hydroxide (colloidal lead hydroxide), so that lead ions and colloidal lead hydroxide coexist.

### CITATION LIST

### Patent Literature

[PTL 1] JP 9-99284 A

[PTL 2] JP 3199733 B

### Non Patent Literature

[NPL 1] NSF/ANSI 53-2018 Drinking water treatment units

### SUMMARY OF INVENTION

### Technical Problem

The present inventors have found that a zeolite and an amorphous titanosilicate can adsorb lead in water with a pH of less than 8, but cannot sufficiently adsorb lead in water with a pH of 8 or more. Thus, an object to be achieved is set so as to provide means capable of adsorbing lead even from water with a pH of 8 or more.

### Solution to Problem

As a result of intensive study of the problem, the present inventors have found that a porous body of a titanium-containing compound, which has a bulk specific gravity in a specific range, can adsorb lead in water with a pH of 8 or more. The present invention has been made based on these findings.

Namely, the present invention relates to the following [1] to [11].

[1] A heavy metal adsorbent including a porous body of a titanium-containing compound, wherein
the porous body has a bulk specific gravity of 0.4 g/cm³ or less.

[2] The adsorbent according to [1], wherein the volume of pores having a pore size of 2 to 10 nm is 0.02 cm³/g or more in the porous body.

[3] The adsorbent according to [1] or [2], wherein the porous body has a BET specific surface area of 50 m²/g or more.

[4] The adsorbent according to any one of [1] to [3], wherein the titanium content of the porous body is 5% by mass or more.

[5] The adsorbent according to any one of [1] to [4], wherein the porous body is a reaction product of a silicate of an alkali earth metal and a water-soluble titanium salt.

[6] The adsorbent according to any one of [1] to [5], which is a lead adsorbent.

[7] The adsorbent according to any one of [1] to [6], further including an additional heavy metal adsorbing substance.

[8] The adsorbent according to [7], wherein the additional heavy metal adsorbing substance is a zeolite or an amorphous titanosilicate (excluding a porous body of an amorphous titanosilicate having a bulk specific gravity of 0.4 g/cm³ or less).

[9] The adsorbent according to any one of [1] to [8], which is an adsorbent for water with a pH of 8 or more.

[10] The adsorbent according to any one of [1] to [9], which is an adsorbent for water purifier.

[11] A water purifier including the adsorbent according to any one of [1] to [10].

### Advantageous Effects of Invention

As shown in Examples mentioned below, in accordance with the present invention, it is possible to adsorb lead in water with a pH of 8 or more. Therefore, the present invention can provide a heavy metal adsorbent having the product value not found in conventional products, and a water purifier utilizing the same.

### DESCRITION OF EMBODIMENT

The heavy metal adsorbent of the present invention (hereinafter also referred to as “adsorbent”) includes a porous body of a titanium-containing compound as an essential component.

[Porous Body of Titanium-Containing Compound (hereinafter also referred to as “porous body”)]

A porous body is used to adsorb heavy metal.

The porous body is composed of a titanium-containing compound. The content of titanium based on the total mass of the titanium-containing compound is, for example, 3 to 60% by mass, preferably 5 to 50% by mass, and more preferably 8 to 30% by mass.

The titanium-containing compound may include elements other than titanium. Examples of elements other than titanium include one or more elements selected from the group consisting of silicon, aluminum, calcium, magnesium, sodium and sulfur.

The content of silicon based on the total mass of the titanium-containing compound is, for example, 0 to 60% by mass, preferably 5 to 50% by mass, and more preferably 10 to 40% by mass.

The content of aluminum based on the total mass of the titanium-containing compound is, for example, 0 to 60% by mass, preferably 5 to 50% by mass, and more preferably 10 to 40% by mass.

The content of calcium based on the total mass of the titanium-containing compound is, for example, 0 to 60% by mass, preferably 3 to 50% by mass, and more preferably 5 to 40% by mass.

The content of magnesium based on the total mass of the titanium-containing compound is, for example, 0 to 60% by mass, preferably 0 to 50% by mass, and more preferably 0 to 40% by mass.

The content of sodium based on the total mass of the titanium-containing compound is, for example, 0 to 30% by mass, preferably 3 to 20% by mass, and more preferably 5 to 15% by mass.

The content of sulfur based on the total mass of the titanium-containing compound is, for example, 0 to 20% by mass, preferably 0 to 15% by mass, and more preferably 0 to 10% by mass.

The bulk specific gravity of the porous body is 0.4 g/cm³ or less, preferably 0.3 g/cm³ or less, and more preferably 0.25 g/cm³ or less.

The bulk specific gravity can be measured in accordance with the method mentioned in JIS K 5101-12-1, Part 12: Apparent Density or Apparent Specific Volume, Section 1: Static Method.

The volume of pores having a pore size of 2 to 10 nm (hereinafter also referred to as “pore volume”) in the porous body is preferably 0.02 cm³/g or more, more preferably 0.03 cm³/g or more, and particularly preferably 0.05 cm³/g or more. When the pore volume is 0.02 cm³/g or more, it is possible to further improve the heavy metal adsorption ability.

The pore volume can be measured in accordance with the method mentioned below.

Using a fully automatic gas adsorption analyzer (AutosorbiQ, manufactured by Quantachrome Instruments), the measurement is performed. Specifically, the measurement is performed by an argon adsorption method and then the pore volume at the pore size is determined from data of the adsorption amount by a DFT method. Vacuum degassing is performed at 200° C. for 6 hours as a pretreatment of a sample.

The BET specific surface area of the porous body is preferably 50 m²/g or more, and more preferably 100 m²/g or more. When the BET specific surface area is 50 m²/g or more, it is possible to further improve the heavy metal adsorption ability.

The BET specific surface area can be measured in accordance with the method mentioned below.

Using a fully automatic gas adsorption analyzer (AutosorbiQ, manufactured by Quantachrome Instruments), the measurement is performed. Specifically, the measurement is performed by an argon adsorption method and then the specific surface area is determined by analysis using a BET multipoint adsorption method. Vacuum degassing is performed at 200° C. for 6 hours as a pretreatment of a sample.

The median diameter of the porous body is preferably 10 μm or more, more preferably 10 to 1,000 μm, and particularly preferably 10 to 50 μm. When the median diameter is 10 μm or more, it is possible to reduce outflow of an adsorbent from a water purifier filter when the adsorbent is used for a water purifier and clogging of a water purifier filter due to the adsorbent.

The median diameter can be measured in accordance with a laser diffraction/scattering particle size distribution analysis method.

The porous body can be prepared by utilizing the following reaction (A) or (B).

(A) Reaction between a hydroxide, an oxide or a silicate of an alkali earth metal and a water-soluble titanium salt

(B) Reaction between titanium oxide, titanium hydroxide or metatitanic acid and an alkali

### [Reaction (A)]

Examples of the hydroxide, the oxide or the silicate of the alkali earth metal include magnesium silicate, calcium silicate, calcium hydroxide, calcium oxide, magnesium hydroxide, magnesium oxide and the like.

Of the hydroxide, the oxide or the silicate of the alkali earth metal, silicate is preferable from the viewpoint of ease of preparation of the porous body having the above-mentioned bulk specific gravity, pore volume and BET value, magnesium silicate and calcium silicate are more preferable, and calcium silicate is particularly preferable.

Examples of the water-soluble titanium salt include titanyl sulfate, titanium sulfate, titanium chloride and the like.

Examples of the method utilizing the reaction (A) are as follows.

To a water suspension of calcium silicate (for example, a concentration of 1 to 50% by mass), an aqueous solution of titanyl sulfate (for example, a concentration of 5 to 40% by mass) is added dropwise at room temperature over a predetermined time (for example, for 1 to 300 minutes), followed by stirring at room temperature for a predetermined time (for example, for 1 to 72 hours). The precipitate thus produced is subjected to filtration, washing and drying (for example, at 50 to 300° C. for 1 to 72 hours) and then the solid thus obtained is pulverized to obtain a titanium-containing compound.

In the above preparation method, control of the bulk specific gravity, the pore volume, the BET specific surface area and the titanium content of the porous body can be carried out by varying the type of raw materials (a hydroxide, an oxide or a silicate of an alkali earth metal), the amount and the speed of dropwise addition of a water-soluble titanium salt, and the drying temperature.

### [Reaction (B)]

Examples of the alkali include sodium hydroxide, potassium hydroxide, ammonia water, sodium silicate and the like, and sodium hydroxide and potassium hydroxide are preferable and sodium hydroxide is more preferable.

Examples of the method utilizing the reaction (B) are as follows.

To a sodium hydroxide solution (for example, concentration of 1 to 10 M), titanium oxide (TiO₂) is added, followed by subjecting to a heat treatment (for example, at 50 to 200° C. for 1 to 72 hours) and further stirring. The precipitate thus produced is subjected to filtration, washing and drying (for example, at 50 to 300° C. for 1 to 72 hours), and then the solid thus obtained is pulverized to obtain a titanium-containing compound.

In the above preparation method, control of the bulk specific gravity, the pore volume, the BET specific surface area and the titanium content of the porous body can be carried out by varying the particle size of titanium raw materials (titanium oxide, etc.), the concentration of the alkali, the heating temperature, and the reaction time.

The porous body may be used alone, or a plurality thereof may be used in combination.

The content of the porous body is preferably 5 to 70% by mass, more preferably 10 to 60% by mass, and particularly preferably 20 to 50% by mass, based on the total mass of the adsorbent. In aspects including the below-mentioned optional components (additional heavy metal adsorbing substance, etc.), the mass of optional components is included in “total mass of the adsorbent”.

While the present invention is not intended to be bound by specific theory, the reason why lead can be adsorbed from water with a pH of 8 or more in accordance with the present invention is as follows.

When the pH of water is less than 8, lead has a high tendency to dissolve in water and exist as lead ions. When the pH of water is 8 or more, lead ions are partially converted into colloids of a hydroxide (colloidal lead hydroxide), so that lead ions and colloidal lead hydroxide coexist (NSF/ANSI 53-2018 Drinking water treatment units).

A zeolite and an amorphous titanosilicate can adsorb lead in water with a pH of less than 8, but cannot sufficiently adsorb lead from water with a pH of 8 or more (Reference Example mentioned below). Therefore, it is considered to be lead ions which are adsorbed by the zeolite and the amorphous titanosilicate.

Meanwhile, the porous body according to the present invention can sufficiently adsorb lead from water with a pH of 8 or more (Examples mentioned below). Therefore, it is considered that the porous body according to the present invention removes lead from water with a pH of 8 or more by adsorbing a colloidal lead hydroxide.

### [Optional Components]

The adsorbent of the present invention may include the following optional components as long as the effects of the invention are not impaired.

### [Additional Heavy Metal Adsorbing Substance]

Mixing of “additional heavy metal adsorbing substance” other than “porous body of titanium-containing compound” mentioned above makes it possible to increase the heavy metal removal ability of the adsorbent.

The additional heavy metal adsorbing substance may be used alone, or a plurality thereof may be used in combination.

A known substance having heavy metal adsorption ability can be used as the additional heavy metal adsorbing substance without any limitations, and a zeolite and an amorphous titanosilicate are preferable.

Since a zeolite and an amorphous titanosilicate adsorb lead ions in water, it is possible to further increase the lead removal ability of the adsorbent by using in combination with “porous body of the titanium-containing compounds” which is considered to adsorb a colloidal lead hydroxide in water.

The mixing ratio in the above combination can be adjusted based on the pH of the water. For example, it is possible to further increase the lead removal ability of the adsorbent as a whole by increasing the amount of the zeolite and the amorphous titanosilicate mixed for water with a pH of less than 8, which has a high existence ratio of lead ions, and by increasing the amount of “porous body of the titanium-containing compound” mixed for water with a pH of 8 or more, which has a high existence ratio of the colloidal lead hydroxide.

### [Zeolite (Aluminosilicate)]

In the present invention, a zeolite adsorbing heavy metal can be used without any limitations.

The zeolite may be either a synthetic zeolite or a natural zeolite, and is preferably a synthetic zeolite.

Examples of the synthetic zeolite include an A-type zeolite, an X-type zeolite, a Y-type zeolite, a P-type zeolite, a T-type zeolite, an L-type zeolite, a β-type zeolite and the like. Of these, an A-type, X-type, Y-type or P-type zeolite is preferable.

Examples of the natural zeolite include sodalite, mordenite, analcime, clinoptilolite, chabazite, erionite and the like.

The median diameter of the zeolite is preferably 10 μm or more, more preferably 10 to 1,000 μm, and particularly preferably 20 to 50 μm. When the median diameter is 10 μm or more, it is possible to reduce outflow of the adsorbent from a water purifier filter when the adsorbent is used for a water purifier and clogging of the water purifier filter due to the adsorbent.

The median diameter can be measured in accordance with a laser diffraction/scattering particle size distribution analysis method.

The content of the zeolite can be appropriately set depending on the pH of water, and is preferably 30 to 95% by mass, more preferably 40 to 90% by mass, and particularly preferably 50 to 80% by mass, based on the total mass of the adsorbent.

The zeolite is a known substance, and is easily available on the market or can be prepared. Examples of a commercially available product include “Zeomic”, manufactured by Sinanen Zeomic Co., Ltd.

The zeolite may be used alone, or a plurality thereof may be used in combination.

### [Amorphous Titanosilicate]

In the present invention, it is possible to use an amorphous titanosilicate adsorbing heavy metal without any limitations. However, a porous body of an amorphous titanosilicate having a bulk specific gravity of 0.4 g/cm³ or less is excluded. In other words, the porous body of an amorphous titanosilicate does not correspond to “porous body of a titanium-containing compound” which is essential component of the present invention.

The median diameter of the amorphous titanosilicate is preferably 10 μm or more, more preferably 10 to 1,000 μm, and particularly preferably 20 to 50 μm. When the median diameter is 10 μm or more, it is possible to reduce outflow of the adsorbent from a water purifier filter when the adsorbent is used for a water purifier and clogging of the water purifier filter due to the adsorbent.

The median diameter can be measured in accordance with a laser diffraction/scattering particle size distribution analysis method.

The content of the amorphous titanosilicate can be appropriately set depending on the pH of water, and is preferably 30 to 95% by mass, more preferably 40 to 90% by mass, and particularly preferably 50 to 80% by mass, based on the total mass of the adsorbent.

The amorphous titanosilicate is a known substance, and is easily available on the market or can be prepared. Examples of a commercially available product include “ATS”, manufactured by BASF Corporation.

The amorphous titanosilicate may be used alone, or a plurality thereof may be used in combination.

### [Activated Carbon]

It is preferable that the adsorbent of the present invention is used in combination with an activated carbon.

The activated carbon is mixed to remove hazardous organic compounds (for example, trihalomethane and formaldehyde) included in water, chlorine odor and moldy odor.

The activated carbon may be in the form of either powder, particle or fiber.

The activated carbon is a known substance, and is easily available on the market or can be prepared.

The activated carbon may be used alone, or a plurality thereof may be used in combination.

The content of the activated carbon is not particularly limited as long as the amount is sufficient to achieve the purpose of mixing, and is preferably 100 to 2,000% by mass, and more preferably 500 to 1,500% by mass, based on the total mass of the adsorbent of the present invention.

### [Method for Producing Adsorbent]

An adsorbent can be produced, for example, by charging a predetermined amount of a porous body of a titanium-containing compound and an additional heavy metal adsorbing substance (zeolite, amorphous titanosilicate, etc.) in a mixer in a powder state (for example, powder having a particle size of 100 μm or less), followed by mixing (for example, for several minutes to several hours) until they become uniform.

The mixer is not particularly limited, and a rocking mixer, a ribbon mixer, a Henschel mixer and the like can be industrially used.

Alternatively, the adsorbent can also be produced by putting a porous body of a titanium-containing compound and an additional heavy metal adsorbing substance (zeolite, amorphous titanosilicate, etc.) into water, followed by stirring using a propeller stirrer to prepare a slurry including both components dispersed therein uniformly, and further subjecting to solid-liquid separation and drying.

It is possible to produce an activated carbon filter for water purifier, including the adsorbent of the present invention and an activated carbon used in combination (carbon block, etc.), for example, by mixing an activated carbon and a porous body, or an activated carbon, a porous body and an additional heavy metal adsorbing substance with a predetermined amount of a binder (polyethylene powder, fibrillated fiber, etc.) and then subjecting the mixture to a molding step.

### [Heavy Metal to be Adsorbed]

There is no particular limitation on the type of heavy metal to be adsorbed. Examples of the heavy metal include lead and mercury. The present invention is particularly suited for removal of lead.

### [Applications of Adsorbent]

An adsorbent can be used to remove heavy metal from water (particularly, tap water). Particularly, the adsorbent can be suitably used as an adsorbent for water purifier, which removes lead from tap water.

The present invention is suited for removal of heavy metal from water with a pH of 8 or more in which sufficient heavy metal removal effect could not be obtained by conventional heavy metal adsorbents (zeolite and amorphous titanosilicate).

### Examples

The present invention will be further described in detail below by way of Examples, but the present invention is not limited thereto.

### [Porous Body of Titanium-Containing Compound]

Porous bodies of the following titanium-containing compounds A to H were used.

### [Porous Body of Titanium-Containing Compound A]

30 g of magnesium silicate was suspended in 200 ml of water to prepare a water suspension having the concentration of magnesium silicate of about 13.0% by mass.

24 g of titanyl sulfate was dissolved in 200 ml of water to prepare an aqueous solution having the concentration of titanyl sulfate of about 10.7% by mass.

To a water suspension of magnesium silicate, an aqueous solution of titanyl sulfate was added dropwise at room temperature over 1 hour, followed by stirring at room temperature for 18 hours. The precipitate thus produced was filtered, washed with water, and then dried at 100° C. for 24 hours. The solid thus obtained was pulverized by a portable pulverizer to obtain a porous body of a titanium-containing compound A.

### [Porous Body of Titanium-Containing Compound B]

30 g of calcium silicate was suspended in 300 ml of water to prepare a water suspension having a concentration of calcium silicate of about 9.1% by mass.

12 g of titanyl sulfate was dissolved in 200 ml of water to prepare an aqueous solution having a concentration of titanyl sulfate of about 5.7% by mass.

To a water suspension of calcium silicate, an aqueous solution of titanyl sulfate was added dropwise at room temperature over 30 minutes, followed by stirring at room temperature for 18 hours. The precipitate thus produced was filtered, washed with water, and then dried at 100° C. for 24 hours. The solid thus obtained was pulverized by a portable pulverizer to obtain a porous body of a titanium-containing compound B.

### [Porous Body of Titanium-Containing Compound C]

In accordance with the same production method as in the titanium-containing compound B, except that the amount of titanyl sulfate used was changed to 24 g, a porous body of a titanium-containing compound C was obtained.

### [Porous Body of Titanium-Containing Compound D]

In accordance with the same production method as in the titanium-containing compound B, except that the amount of titanyl sulfate used was changed to 36 g, a porous body of a titanium-containing compound D was obtained.

### [Porous Body of Titanium-Containing Compound E]

To 100 ml of a sodium hydroxide solution (concentration: 7 M), 5 g of titanium oxide was added, followed by subjecting to a heat treatment at 100° C. for 24 hours while stirring. Thereafter, the precipitate thus produced was filtered, washed with water and then dried at 100° C. for 24 hours. The solid thus obtained was pulverized by a portable pulverizer to obtain a porous body of a titanium compound E.

### [Porous Body of Titanium-Containing Compound F]

In accordance with the same production method as in the titanium-containing compound B, except that calcium silicate was changed to aluminum silicate, a porous body of a titanium-containing compound F was obtained.

### [Porous Body of Titanium-Containing Compound G]

In accordance with the same production method as in the titanium-containing compound C, except that calcium silicate was changed to wollastonite (natural calcium silicate), a porous body of a titanium-containing compound G was obtained.

### [Porous Body of Titanium-Containing Compound H]

In accordance with the same production method as in the titanium-containing compound A, except that the amount of titanyl sulfate used was changed to 36 g, a porous body of a titanium-containing compound H was obtained.

### [Porous Body of Titanium-Free Compound]

A porous body of a commercially available magnesium silicate (trade name: AD600, manufactured by Tomita Pharmaceutical Co., Ltd.) was used.

In accordance with the measurement methods mentioned above, “bulk specific gravity”, “volume of pores having a pore size of 2 to 10 nm” and “BET specific surface area” of each porous body were measured. The results are shown in Table 1.

Elemental composition of compounds constituting each porous body was measured by order analysis using an X-ray fluorescence spectrometer (ZSXPrimusII, manufactured by Rigaku Corporation). As samples for measurement, those obtained by placing each compound in a 35 mmφ vinyl chloride ring and sandwiching the ring between dice, followed by pelletization by application of 10 MPa pressure in a press machine, were used. The results are shown in Table 2. The value of each element shown in Table 2 is the content (% by mass) based on the total mass of the compound.

### [Additional Heavy Metal Adsorbing Substance]

### [Zeolite]

A commercially available X-type zeolite (trade name: Zeomic, manufactured by Sinanen Zeomic Co., Ltd.) was used.

The zeolite did not include titanium and had a bulk specific gravity of 0.651 g/cm³.

### [Amorphous Titanosilicate]

A commercially available amorphous titanosilicate (trade name: ATS, manufactured by BASF Corporation) was used.

The titanium content of this amorphous titanosilicate was 32.2% by mass, the silicon content was 15.4% by mass, and the sodium content was 6.1% by mass. “Bulk specific gravity” of this amorphous titanosilicate was 0.876 g/cm³, “volume of pores having a pore size of 2 to 10 nm” was 0.090 cm³/g, and “BET specific surface area” was 192 m²/g.

### [Adsorption Test of Lead]

### [Preparation of Test Water]

A predetermined amount of lead nitrate was dissolved in distilled water to prepare a lead solution having a lead concentration of 300 ppm.

8 ml of a lead solution was added to 7,992 ml of simulated tap water (leaching solution defined in JIS S3200-7: pH of 7.0±0.1, hardness of 45±5 mg/L, alkalinity of 35±5 mg/L, residual chlorine of 0.3 mg±0.1 mg/L), and then the pH was adjusted to 8.9 with 1 N sodium hydroxide to obtain test water having a lead concentration of 300 ppb.

### [Adsorption Test]

To 8,000 ml of test water, a porous body of a titanium-containing compound and/or an additional heavy metal adsorbing substance were/was added in the amount shown in Table 1, followed by stirring at 100 rpm for 24 hours. Thereafter, solid-liquid separation was performed using a 0.8 μm membrane filter, and then the residual lead concentration (ppb) in the filtrate was measured by graphite furnace atomic absorption spectrophotometry (ZA3000, manufactured by Hitachi High-Tech Science Corporation). The results are shown in Table 1.

The membrane filter used in solid-liquid separation (separation between the adsorbent and the test water) is not capable of separating lead from the test water

### (Reference Example Mentioned Below)

In the test water with a pH of 8.9, as compared with conventional adsorbents (Comparative Examples 1 to 3), the adsorbent of the present invention (Example 7) exhibited excellent lead adsorption ability. The lead adsorption ability was improved by using the adsorbent of the present invention in combination with the additional heavy metal adsorbing substances (Examples 6 and 7).

### [Adsorption Test of Mercury]

### [Preparation of Test Water]

A predetermined amount of mercury chloride was dissolved in distilled water to prepare a mercury solution having a mercury concentration of 25 ppm.

1 ml of the mercury solution was added to 499 ml of tap water to obtain test water having a mercury concentration of 50 ppb. The pH of the test water was 6.8. In water with a pH of 4 or more, most of mercury exists as a colloidal mercury hydroxide (Adsorption Processing for the Removal of Toxic Hg(II) from Liquid Effluents: Metals 2020, 10(3), 412).

To 500 ml of test water, a porous body of a titanium-containing compound and/or an additional heavy metal adsorbing substance were/was added in the amount shown in Table 3, followed by stirring at 100 rpm for 24 hours. Thereafter, solid-liquid separation was performed using a 0.8 μm membrane filter, and then the residual mercury concentration (ppb) in the filtrate was measured by a reduced vaporized atomic absorption spectroscopy (Mercury RA-3, manufactured by Nippon Instruments Corporation). The results are shown in Table 3.

As compared with a conventional adsorbent (Comparative Example 9), the adsorbents of the present invention (Examples 8 to 9) also exhibited excellent adsorption ability to mercury.

### [Reference Example: Lead Adsorption Ability of Additional Heavy Metal Adsorbing Substance]

### [Preparation of Test Water]

A predetermined amount of lead nitrate was dissolved in distilled water to prepare a lead solution having a lead concentration of 300 ppm.

8 ml of a lead solution was added to 7,992 ml of simulated tap water (leaching solution defined in JIS S3200-7: pH of 7.0±0.1, hardness of 45±5 mg/L, alkalinity of 35±5 mg/L, residual chlorine of 0.3 mg±0.1 mg/L), and then the pH was adjusted to 6.7 or 8.9 with 1 N hydrochloric acid or 1 N sodium hydroxide to obtain test water having a lead concentration of 300 ppb.

### [Adsorption Test]

To 8,000 ml of test water, an additional heavy metal adsorbing substance was added in the amount shown in Table 4, followed by stirring at 100 rpm for 24 hours. Thereafter, solid-liquid separation was performed using a 0.8 μm membrane filter, and then the residual lead concentration (ppb) in the filtrate was measured by graphite furnace atomic absorption spectrophotometry (ZA3000, manufactured by Hitachi High-Tech Science Corporation). The results are shown in Table 4.

All heavy metal adsorbing substances adsorbed almost all lead from the test solution with a pH of 6.7, but lead remained in the test solution with a pH of 8.9.

While lead has a high tendency to exist as lead ions in water with a pH of 6.7, lead ions and colloidal lead hydroxide coexist in water with a pH of 8.9 (NSF/ANSI 53-2018 Drinking water treatment units).

Therefore, it is considered that lead remained without being adsorbed from the test solution with a pH of 8.9 is a colloidal lead hydroxide and the additional heavy metal adsorbing substance is a substance adsorbing lead ions in water.

In a control test wherein the additional heavy metal adsorbing substance was not added, since the lead concentration in the test water after filtration with a 0.8 μm membrane filter scarcely changed compared with the lead concentration before the test (300 ppb), it is considered that the membrane filter used in solid-liquid separation is not capable of separating lead (lead ions and colloidal lead hydroxide) from the test water.

### Industrial Applicability

The present invention can be utilized in the technical field where removal of heavy metal is requited, particularly water purifier field.

TABLE 1

| | | | Porous body of titanium-containing compound | | | | | |
|---|---|---|---|---|---|---|---|---|
| | | | Type and Physical properties | | | | | |
| | Additional heavy metal | | | | | BET | | |
| | adsorbing substance | | | Bulk | | specific | | |
| | | Amount | | specific | Pore | surface | Amount | Lead |
| | | used | | gravity | volume | area | used | concentration |
| | Type | (mg) | Type | (g/cm³) | (cm³/g) | (m²/g) | (mg) | (ppb) |
| Example 1 | Zeolite | 20 | Titanium- | 0.344 | 0.128 | 280 | 20 | 9 |
| | | | containing | | | | | |
| | | | compound A | | | | | |
| Example 2 | Zeolite | 20 | Titanium- | 0.121 | 0.075 | 112 | 20 | 7 |
| | | | containing | | | | | |
| | | | compound B | | | | | |
| Example 3 | Zeolite | 20 | Titanium- | 0.198 | 0.101 | 253 | 20 | 5 |
| | | | containing | | | | | |
| | | | compound C | | | | | |
| Example 4 | Zeolite | 20 | Titanium- | 0.380 | 0.028 | 79 | 20 | 16 |
| | | | containing | | | | | |
| | | | compound D | | | | | |
| Example 5 | Zeolite | 20 | Titanium- | 0.373 | 0.052 | 250 | 20 | 2 |
| | | | containing | | | | | |
| | | | compound E | | | | | |
| Example 6 | Amorphous | 20 | Titanium- | 0.198 | 0.101 | 253 | 20 | 5 |
| | titanosilicate | | containing | | | | | |
| | | | compound C | | | | | |
| Example 7 | — | — | Titanium- | 0.198 | 0.101 | 253 | 40 | 43 |
| | | | containing | | | | | |
| | | | compound C | | | | | |
| Comparative | Zeolite | 20 | — | — | — | — | — | 122 |
| Example 1 | | | | | | | | |
| Comparative | Zeolite | 40 | — | — | — | — | — | 110 |
| Example 2 | | | | | | | | |
| Comparative | Amorphous | 40 | — | — | — | — | — | 100 |
| Example 3 | titanosilicate | | | | | | | |
| Comparative | Zeolite | 20 | Titanium- | 0.516 | 0.081 | 191 | 20 | 110 |
| Example 4 | | | containing | | | | | |
| | | | compound F | | | | | |
| Comparative | Zeolite | 20 | Titanium- | 0.623 | 0.023 | 89 | 20 | 72 |
| Example 5 | | | containing | | | | | |
| | | | compound G | | | | | |
| Comparative | Zeolite | 20 | Titanium- | 0.494 | 0.169 | 117 | 20 | 61 |
| Example 6 | | | containing | | | | | |
| | | | compound H | | | | | |
| Comparative | Zeolite | 20 | Amorphous | 0.876 | 0.090 | 192 | 20 | 94 |
| Example 7 | | | titanosilicate | | | | | |
| Comparative | Zeolite | 20 | Titanium- | 0.395 | 0.247 | 273 | 20 | 75 |
| Example 8 | | | free | | | | | |
| | | | compound | | | | | |
| control | — | — | — | — | — | — | — | 290 |

TABLE 2

| | Content (% by mass) | | | | | | |
|---|---|---|---|---|---|---|---|
| | Ti | Si | Al | Ca | Mg | Na | S |
| Titanium-containing compound A | 18.4 | 28.4 | — | — | 0.2 | — | 0.9 |
| Titanium-containing compound B | 8.7 | 26.4 | — | 12.5 | — | — | 2.2 |
| Titanium-containing compound C | 12.9 | 21.8 | — | 9.7 | — | — | 5.9 |
| Titanium-containing compound D | 17.2 | 16.9 | — | 7.0 | — | — | 8.6 |
| Titanium-containing compound E | 46.7 | — | — | — | — | 9.3 | — |
| Titanium-containing compound F | 9.2 | 32.6 | 4.1 | — | — | — | 1.1 |
| Titanium-containing compound G | 12.9 | 14.1 | — | 19.0 | — | — | 6.7 |
| Titanium-containing compound H | 7.8 | 37.8 | — | — | 0.2 | — | 0.7 |

TABLE 3

| | | Amount | Mercury |
|---|---|---|---|
| | Adsorbent | used (mg) | concentration (ppb) |
| Example 8 | Titanium-containing | 50 | 2.3 |
| | compound C | | |
| Example 9 | Titanium-containing | 50 | 0.3 |
| | compound E | | |
| Comparative | Zeolite | 50 | 24.0 |
| Example 9 | | | |
| Control | — | — | 44.0 |

TABLE 4

| | Additional heavy metal adsorbing | | | |
|---|---|---|---|---|
| | adsorbing substance | | | |
| | | Amount used | Lead concentration (ppb) | |
| | Type | (mg) | pH = 6.7 | pH = 8.9 |
| Reference | Zeolite | 40 | 2 | 110 |
| Example 1 | | | | |
| Reference | Amorphous | 40 | 3 | 100 |
| Example 2 | titanosilicate | | | |
| Control | — | — | 298 | 290 |

What is claimed is:

1. A heavy metal adsorbent comprising a porous body of a titanium-containing compound, wherein
the porous body has a bulk specific gravity of 0.4 g/cm³ or less.

2. The adsorbent according to claim 1, wherein the volume of pores having a pore size of 2 to 10 nm is 0.02 cm³/g or more in the porous body.

3. The adsorbent according to claim 1, wherein the porous body has a BET specific surface area of 50 m²/g or more.

4. The adsorbent according to claim 1, wherein the titanium content of the porous body is 5% by mass or more.

5. The adsorbent according to claim 1, wherein the porous body is a reaction product of a silicate of an alkali earth metal and a water-soluble titanium salt.

6. The adsorbent according to claim 1, which is a lead adsorbent.

7. The adsorbent according to claim 1, further comprising an additional heavy metal adsorbing substance.

8. The adsorbent according to claim 7, wherein the additional heavy metal adsorbing substance is a zeolite or an amorphous titanosilicate (excluding a porous body of an amorphous titanosilicate having a bulk specific gravity of 0.4 g/cm³ or less).

9. The adsorbent according to claim 1, which is an adsorbent for water with a pH of 8 or more.

10. The adsorbent according to claim 1, which is an adsorbent for water purifier.

11. A water purifier comprising the adsorbent according to claim 1.
